(19) United States
(12) Patent Application Publication
(10) Pub. No.: US 2003/0081951 A1
(43) Pub. Date: May 1, 2003

(54) METHOD AND DEVICE FOR SHOOTING SPHERICAL PICTURES TO PRODUCE A THREE-DIMENSIONAL IMAGE MATRIX OF AN OBJECT

(76) Inventor: ERIC BELMON, BOULOGNE (FR)

Correspondence Address: ERIC BELMON, 923 RESIDENCE AQUITAINE, BOULOGNE, 92100, FR

(21) Appl. No.: 09/230,796

(22) PCT Filed: Jun. 5, 1998
(86) PCT No.: PCT/FR98/01144

(30) Foreign Application Priority Data
Jun. 9, 1997 (FR) 97/07113

(51) Int. Cl. G03B 35/00

(52) U.S. Cl. 396/324

(57) ABSTRACT

The invention concerns a method and a device for shooting spherical pictures to produce a succession of digitised images about an object (6), in order to subsequently enable a three-dimensional observation of said object by computer means. The invention is in particular useful for producing digitised film representing an object rotating about its centre of rotation.

### DESCRIPTION

1. Scope of the Invention

The invention concerns a process and a device of spherical capture in the aim to realize a succession of digitized images around an object in order to allow, afterwards, a tridimensional observation of the said object, through computer means. It allows, in particular, the realization of digitized motion pictures representing the object rotating around its rotation axis.

2. State of the Art

A spherical capture system is represented on the commercial brochure of PEACE RIVER STUDIOS, at Cambridge, USA. This system entails an arch made of a horizontal arm bearing a camera and mounted on two levers rotating around a common axis. At the center of this arch, the object of which one seeks to take pictures of is positioned on a stand turning around a vertical axis. A computerized system ensures the control of the arch and the camera.

The arch ensures a shifting in rotation of the camera around the object and the camera realizes many captures of the object during this shifting. Meanwhile, the object turns around itself by Means of the stand.

A first drawback of this system resides in the setting of the horizontal arm on which the camera is fixed. In fact, the arm setting is done by two levers which movement is quite irregular, which leads to a less precise tuning which is however difficult and long to set. Thus, the size of the

Spherical trajectory one seeks to make around the object is difficult to regulate.

The second drawback of this system resides in the lighting. In fact, the lighting of the object, for capture, is associated with the camera, this means that it varies while the camera moves, that can create different shadows depending on the move of the camera as well as on the shadows related to the arch itself.

Another drawback of this system resides in the manual setting of the camera's position on the horizontal arm. In fact, this tuning is done vis-a-vis the object's rotation center. But, the object's rotation center is predefined in function of the size of the sphere and the position of the camera on the arch, and the position of this rotation center cannot be modified. Thus, it is the object itself which is set regarding the rotation center (especially when the object is big).

Furthermore, this system presents a lack of precision regarding the positioning of the object relating to its rotation center, that could lead to unwedged successive pictures.

Besides, the distance camera-object must be regulated manually before takes, which is long and fastidious to set and allows no possible adaptation considering the size of the object. The variation of the object's size on the picture is done through a telephoto lens which leads, as a man of the art knows well, to pictures which perspectives are altered.

Moreover, this system has the drawback to need a very big volume reserved to its functioning. In fact, the arch moving in its whole around the object, it is necessary to get, around the said object, a volume two times bigger than the size of the arch levers. Furthermore, the important bulkiness of this systems makes it hard to carry. So, the PEACE RIVER STUDIO company has realized a transportable system, in which the distance camera-object is not adjustable and which results are less precise.

### Expose of the Invention

The invention has the aim to cure the drawbacks of the system above described. To this means it proposes a process and a device of spherical takes allowing the realization a succession of precise pictures which can be assembled to make a motion picture showing the object rotating around its rotating center, to allow seeing this object later.

In a more precise way, the invention concerns a spherical shooting process for the realization of a 3D pictures matrix of an object. This process characterizes as it consists to:

a) analyze, in connection with a virtual rotation center, the positioning of an articulated arm bearing a means of shooting; and center the object, through a picture analysis, per report of its rotation center;

b) position the object, according to a reference position, on a pole rotating around a vertical axis;

c) position a means of shooting according to a first position on a spherical basis trajectory predefined around the object;

d) do a first shooting of the object;

e) move the object one step in rotation and do another shooting of the object;

f) repeat step e) so long as the object is back to its reference position;

g) move the shooting means one step on its trajectory and do a shooting of the object;

h) repeat steps c) to h) so long as the means for shooting has run all its predefined trajectory.

Advantageously, the invention process consists first of all of a a1) initialization and memorization step which includes the following operations:

definition of space parameters in which the articulated arm is;

definition of shooting parameters;

definition of the camera's trajectory around the object and of the number of shootings.

According to the invention, the process includes a step a 3) of:

potential alteration of the proposed trajectory; and

memorization of a present scenario relative to the object, to the chosen trajectory, as well as to the defined parameters.

According to a realization mode of the invention, the invention process consists on a step j) for the treatment of the shootings got from step b) to h) to produce a 3D pictures matrix.

This process has the advantage to offer a wholly programmed shifting of the articulated arm's both axis, which allow getting always well centered pictures and, thus, a fluid film.

Moreover, the articulated arm's trajectory is redefined and eventually altered for each object to be captured (to be shot), which allows the shooting of all kinds of objects, whatever their size (for example, a motor car or an insect).

Furthermore, each scenario is memorized (one name “scenario” the whole circumstances relative to an object shooting : chosen trajectory, defined parameters, etc.). Later, these memorized scenario could be researched in the memory by the user for a new object to be shot which form resembles one of an already captured object (shot). Each memorized scenario can be altered by the user; this altered scenario is again memorized by the system.

The invention also concerns a spherical shooting system implementing the above described process. This systems includes:

a tripod on which the object is positioned and which is able to gyrate around a vertical axis so as to make the object bear a rotation in an horizontal plan;

an articulated arm in which end is fixed, on a mobile way, a digital shooting means which describes, on a vertical plan, a spherical trajectory or an altered spherical trajectory around the object;

command and treatment means ensuring the command and the synchronization of the articulated arm, of the shooting means and of the prop of the object, and the treatment of the pictures realized through the shooting means.

Advantageously, the articulated arm has at least two segments articulated among them, according to two horizontal axis parallel one to the other.

According to a realization mode of the invention, the articulated arm is mounted on a vertical support, mobile around a vertical axis.

According to another realization mode of the invention, the articulated arm is mounted on a mobile cart.

According to the invention the object's support is mounted on a shifting table.

This system has the advantage to be relatively little bulky, which allows it to be transportable on site to realize pictures matrices on the spot where the objects are in the case, for example, of fragile or voluminous objects, or again in the case of a to big quantity of objects to be shot.

Moreover this systems presents an advantage in the fact that the shooting means (for example a video camera) is free at the end of the articulated arm, and can thus be anywhere around the object, in the limit of the rayon proposed by the articulated arm, of course.

### BRIEF DESCRIPTION OF THE FIGURES

FIG. 1 represents schematically the system of the invention;

FIG. 2 represents schematically the functional diagram showing the different steps of the invention process.

### DETAILED DESCRIPTION OF THE REALIZATION MODE OF THE INVENTION

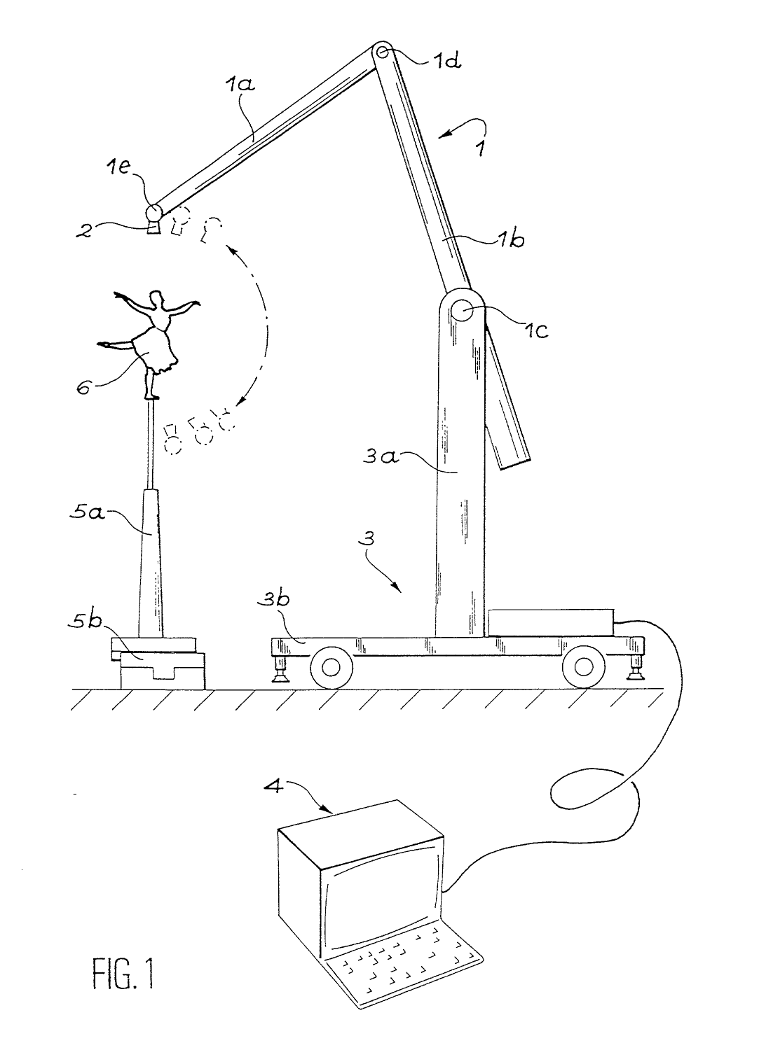

On FIG. 1, one has represented the spherical shooting system conform to the invention. This system includes an articulated arm including to segments 1a and 1b. This articulated arm can include other segments, according to the realization modes.

At the end of this articulated arm 1 is fixed in a mobile way a means to shooting which could be, for example, a video camera 2. This camera 2 is fixed at the end of the articulated arm by means of a rotation axis 1e.

The whole of the articulated arm 1 is fixed on a support 3 by means of a first rotation axis 1c. A second rotation axis 1d allows the rotation between segment 1a and segment 1b of the articulated arm. These two axis 1d and 1c are horizontal and parallel to each other.

According to the realization mode represented on this FIG. 1, the articulated arm's 1 support 3 is a cart bearing a 3a base on which articulated arm's segment 1b is fixed. This base 3a is itself fixed on the frame 3b of the cart.

According to another realization mode, no represented on the figures the articulated arm 1 can be fixed, by means of a rotation axis, on a vertical support, such as a keg, which can be himself mobile round its vertical axis.

On FIG. 1, only one video camera is shown. However, depending certain realization modes, the articulated arm 1 can bear two video cameras which allow to give certain effects to the pictures.

The articulated arm/cart/camera set is run through computer system means 4 which includes a interface allowing the user to choose, at each step, an automatic mode or a manual mode which will be described afterwards.

On the FIG. 1, the object one tries to catch is referenced 6. On the example shown on FIG. 1, this object is a doll. This object being of a relative small size, is set on a vertical support 5a which is mobile around its axis, to allow object 6 to do a rotation on an horizontal plan. Advantageously, this support 5a is placed on a shifting table 5b which allows to shift the support 5a/object 6 set on the horizontal and/or vertical plan, especially to center the object in connection with video camera 2 as will be seen later.

On the example represented on FIG. 1, the object 6 is of a relative small size; it is therefore set on a mobile support. However, when the object to catch is of a more important size, for example, a motor car, it can be set either on a turning table, or directly on the floor.

On this FIG. 1 one has represented the camera 2's trajectory around the object through mixed lines, for a particular case of an small size object 6 set on a support 5a.

One understand easily that the shifting of the camera is easily settable , and thus the size of the trajectory's radius around object 6 is easily alterable through a computer system 4.

Moreover, on sees on this FIG. 1 that the system is relatively little bulky, once the articulated arm is folded and thus, it can be transported easily on site to capture non transportable objects, for example because they are fragile, voluminous, or precious, or simply because they are in plenty and that it is more easy to move the system than moving all the objects.

On this FIG. 1, no lighting has been represented. In fact, this system can be set for all lighting usual for the man of the art. In fact, camera 2 being borne uniquely by an articulated arm, the shadow risk on the object is quasi nil.

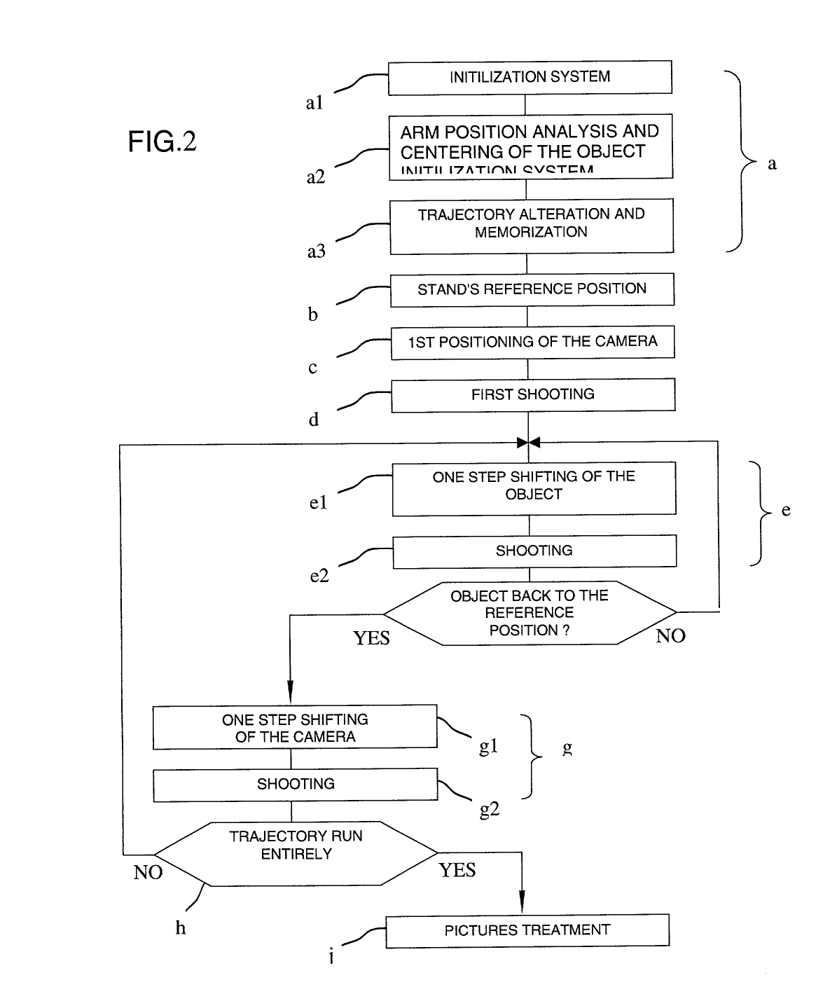

On FIG. 2, one has represented the functional scheme of the spherical shooting process of the invention.

The first step a1) concerns the initialization of the system. This initialization consists, on one hand, to give to the computer system/articulated arm set, which is also named automaton, parameters values and, in particular, parameters regarding the space in which the automaton is. For example the user supplies the automaton with values regarding to the height under roof of the room where it is located, the distance wall to wall and the physical positioning of the automaton in this space. These parameters allow the automaton to get bearings in the space in which it is set and to define its security limits.

This step a1) consists equally in the initialization of the automaton's diverse components and in the physical search of its reference captors.

Besides, it consists in the definition of:

the automaton's capture parameters and, in particular: level number, i.e. number of the photos in height (on the trajectory), number of photos in circumference, i.e. number of photos of the object in rotation, and choice of capture angles;

the picture's settings:

setting of picture acquisition; luminosity, contrast saturation, color, zoom, diaphragm shutter speed, focal, gain, whites setting;

setting of the restitution: picture type, format size, picture compression number of colors;

locking and recording possibility of the various settings and capture configuration;

definition of the object's positioning: dimension between the sphere and the object height between the object-center and the floor, distance between axis 1c and the center object, distance between the camera and the center-object.

The step a2) of the process consists in an automaton's autoanalysis for operational conformity according to a virtual rotation center which can be represented for example, by a luminous point in the space. Otherwise said, it is a picture analysis of a virtual rotation center (par example relating to a LED), allowing the automaton to know if the virtual rotation center is in the same plan as itself. If it is not the case, either the automaton shifts itself, or warns that it should be shifted.

This step a2) includes, moreover, an object centering operation depending it own rotation center, also named “object-center”. This object centering is done, through a picture analysis, from an adjustable mire included in the computer system. This positioning, or centering, of the object depending of it own rotation center can be made either manually by the user, or in an automatic way by the system which then shifts the object, thanks to the shifting table 5b. This object centering is done in 3Ds.

According to the invention, the user can chose the possibility to make semi-automatic captures, i.e. captures in which the arm does move only when an order is sent by the user, which allows the user to intervene upon the object in the course of the process.

These capture settings, that is to say the resolution parameters definition, the positioning of the object, the settings of the pictures, and the semi-automatic capture possibility, can be made in manual mode. They can also be made in automatic mode. The choice of the mode is done by the user, during the course of the process.

In the case of the automatic mode, it is the system which proposes capture sequences and physical settings relying on the analysis it had made of the object (size . . . ), to the user. The user can accept these propositions or alter them (step a3). In case of alterations, the scenario are memorized by the system (step 3a) in order to create a data base. The user can thus deform the initially spherical trajectory proposed by the system and reuse these deformed trajectories when a resembling scenario occurs later.

In fact, depending of the form of the object to capture, it could be interesting to alter the form of the basic spherical trajectory to achieve, for example, an ellipsoidal trajectory, which corresponds better to the elongated form of certain objects.

When all the parameters are defined and the trajectory to be made by the articulated arm also defined, one position the support of the object according to a reference position (step b).

Step c) consists then to position the camera according to a first position on the trajectory to will have to make.

When these support and camera positioning are made, one realizes a first shooting of the object (step d).

Then, the object is shifted in rotation of one step (e1) and a shooting of the object is done (step e2).

When these steps e1) and e2) of the object's shifting and shooting are realized, the system verifies, in a step f), if the object is back to its reference position or not. If not the case, the process begins again from step e1). If it is the case, i.e. if the object is back to its reference position, then the camera is shifted of one step on its predefined trajectory (step g1) and a new shooting is done (step g2).

The system then verifies, in a step h), if the trajectory has been entirely run. If not the case, the process is taken back to step e1) of the object shifting. If the case, i.e. if the camera has taken all the positions planned on the predefined trajectory, then s step j) of pictures' processing is made. This image processing step is classical and it allows to realize, from the picture matrix gotten, a digital film showing the object in space.

All these various operations described for the invention process can be made, either manually by the user, or in an automatic way. The user himself chooses step by step during the course of the process if he wants to work on automatic mode or on manual. This, and the possibility to alter the scenario proposed by the system, allows a wide flexibility of the process with, in particular, an alteration of the trajectory easily made depending on the object to capture.

The apprenticeship proposed by the system allows a considerable gain time as it allows, when a capture of various objects of globally identical form objects is made, to reuse scenarii already memorized, which avoids a re-programming of the system.

Moreover, this process allows a precise determination of the object's rotation center, automatically, thanks to the incorporated line of site in the system. The articulated arm's shifting, entirely programmed, and realized in function of the object center, allow to get centered pictures in a precise way and realized according to a steady step, thus getting a film simulating the fluid and steady evolution of the object in space.

1. Spherical shooting process for the realization of an object's 3Ds matrix , characterized in that it consists to:
a) analyze, depending upon a virtual rotation center, the positioning of an articulated arm bearing a shooting means; and center, thanks to an image analysis, the object in relation with its rotation center;
b) position the object, according to a reference position, on a stand swiveling around a vertical axis;
c) position a shooting means according to a first position on a basic spherical trajectory defined around the object;
d) do a first shooting of the object;
e) move the object one step in rotation and do another shooting of the object;
f) repeat step e) so long as the object comes back to its reference position;
g) move the shooting means one step on its trajectory and do a shooting of the object;
h) repeat steps c) to h) so long as the shooting means has run all its predefined trajectory.

2. According to claim 1, process characterized in that it consists, first of all, in one initialization step a1) which entails the following operations:
definition of space parameters in which the articulated arm is located;
definition of the shooting parameters
definition of the camera's trajectory around the object and of the number of shootings.

3. According to claim 1 or 2, process characterized in that it entails a step a3) of:
possible alteration of the proposed trajectory; and
memorization of a scenario concerning the object, to its chosen trajectory, as well as of the set parameters.

4. According to whichever claim 1 to 3, process characterized in that it consists in a step j) of a treatment of the shooting got from step b) to ) to produce a 3D pictures matrix.

5. Shooting system implementing the process according to whichever claim 1 to 4, characterized in that it entails:
a stand (5a) on which the object is positioned (6) and which is able to turn around a vertical axis so as to make the object do a rotation in an horizontal plan;
an articulated arm (1) at which end is fixed, on a mobile way, at least a digital shooting means (2) and which describes, in a vertical plan, a spherical trajectory or an altered spherical trajectory, around the object;
control and treatment means (4) ensuring the control and synchronization of the articulated arm, of the shooting means and of the object's stand, and the treatment of the pictures realized by the shooting means.

6. According to claim 5, system characterized in that the articulated arm involves at least two segments (1a, 1b), articulated between them according to two horizontal axis (1c, 1d), parallel to each other.

7. According to whichever claim 5 to 6, system characterized in that the articulated arm is mounted on a vertical stand mobile round a vertical axis.

8. According to whichever claim 5 to 6, system characterized in that the articulated arm is mounted on a mobile cart (3).

9. According to whichever claim 5 to 8, system characterized in that the object's stand is mounted on a shifting table (5b).
